(19) United States
(12) Patent Application Publication
(10) Pub. No.: US 2005/0041098 A1
(43) Pub. Date: Feb. 24, 2005

(54) Digital image capturing module assembly and method of fabricating the same

(75) Inventors: Kah-Ong Tan, Shanghai (CN); Jia Shi, Shanghai (CN)

Correspondence Address: EDWARDS & ANGELL, LLP, 101 Federal Street, Boston, MA, 02110, US

(73) Assignee: Inventec Micro-Electronics Corporation

(21) Appl. No.: 10/643,396

(22) Filed: Aug. 18, 2003

(51) Int. Cl. H04N 7/18

(52) U.S. Cl. 348/95

(57) ABSTRACT

A digital image capturing module assembly and method of fabricating the same is proposed, which is used for the assembly of a digital image capturing module from a photosensitive printed circuit board and a lens holder. The proposed assembly method is characterized by the provision of stair-like bulged portions beside the aligning posts on the lens holder to allow the formation of an undergap between the photosensitive printed circuit board and the lens holder, which allows a curable and flowable adhesive agent to self-infiltrate into and substantially fill up the undergap through capillary attraction to provide an absolutely sealed light impenetrable effect without the formation of light-penetrating holes around the aligning posts. This feature also allows the overall assembly process to be more simplified, which can help increase the yield of the fabrication of digital image capturing modules.

### BACKGROUND OF THE INVENTION

1. Field of the Invention

This invention relates to electronics assembly technology, and more particularly, to a digital image capturing module assembly and method of fabricating the same, which is designed for use to assemble a digital image capturing module from a lens holder and a photosensitive printed circuit board (PCB), such as a CCD (Charge Coupled Device) based or a CMOS (Complementary Metal Oxide Semiconductor) based circuit board.

2. Description of Related Art

Digital image capturing module is a key component in the assembly of a digital still camera (DSC) or a camera-equipped electronic device such as mobile phone, which is composed of a lens holder and a photosensitive printed circuit board (PCB), where the lens holder is used to hold a lens unit that is used to capture an optical image and focus the captured image on a focusing plane on the rear side of the lens holder, while the photosensitive printed circuit board is, for example, a CCD (Charge Coupled Device) based or a CMOS (Complementary Metal Oxide Semiconductor) based photosensitive device, which is disposed on the focusing plane of the lens holder for the purpose of converting the optical image focused thereon into digital form.

A conventional method for the assembly of a digital image capturing module from a lens holder and a photosensitive printed circuit board is to use a curable adhesive agent to adhere the photosensitive printed circuit board to the periphery of the focusing plane of the lens holder. After the adhesive agent is cured, it can firmly secure the photosensitive printed circuit board in position on the lens holder and additionally serve as a light-impenetrable sealing layer at the junction between the photosensitive printed circuit board and the lens holder to prevent undesired sidelight from penetrating to the inside of the digital image capturing module that would otherwise degrade the quality of the captured image.

One drawback to the foregoing assembly method, however, is that the coating of the adhesive agent onto the periphery of the focusing plane of the lens holder should be conducted in two passes, wherein the first pass is used to coat the adhesive agent crosswise while the second pass is used to coat the adhesive agent lengthwise. As the coating process is completed, however, uncoated blank spots would exist at the four corners of the periphery of the focusing plane, which would become light-penetrable holes in the adhesive layer. These holes would allow sidelight to pass therethrough to the inside of the lens holder and thus degrade the picture quality of the captured image by the digital image capturing module. One solution to this problem is to use labor force to manually fill up these holes in the cured adhesive layer during subsequent steps. One drawback to this solution, however, is that it would make the overall fabrication process more laborious and time-timing, thus desirably resulting in a low yield to the fabrication of the digital image capturing modules.

### SUMMARY OF THE INVENTION

It is therefore an objective of this invention to provide a new digital image capturing module assembly and method of fabricating the same which can provide a light-impenetrable sealing layer at the junction between the photosensitive printed circuit board and the lens holder without the formation of holes at the corners of the periphery of the focusing plane on the lens holder, and which can also help simplify the assembly process and reduce the required assembly time so as to allow the assembly of digital image capturing modules to be increased in yield.

The digital image capturing module assembly and method of fabricating the same according to the invention is designed for use to assemble a digital image capturing module by mounting an photosensitive printed circuit board, such as a CCD (Charge Coupled Device) based or a CMOS (Complementary Metal Oxide Semiconductor) based circuit board, to a lens holder.

The digital image capturing module assembly and method of fabricating the same according to the invention is characterized by the provision of a plurality of stair-like bulged portions respectively beside the aligning posts on the lens holder to allow the formation of an undergap between the photosensitive printed circuit board and the lens holder so as to allow a curable and flowable adhesive agent to self-infiltrate into and substantially fill up the undergap through capillary attraction, thereby forming a light-impenetrable sealing layer at the junction between the photosensitive printed circuit board and the lens holder without the existence of uncoated blank areas around the aligning posts.

The digital image capturing module assembly and method of fabricating the same according to the invention allows the provision of an absolutely sealed light-impenetrable effect at the junction between the photosensitive printed circuit board and the lens holder so that the captured image by the finished product of the digital image capturing module would be substantially free of sidelight and thus more assured in picture quality. Moreover, since it would be unnecessary to fill up corner-located holes in the sealing layer by labor force as in the case of prior art, the invention can further help increase the yield of the fabrication of digital image capturing modules.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing an exploded perspective view of the various constituent parts used to fabricate a digital image capturing module assembly according to the invention;

FIG. 2 is a schematic diagram showing a sectional view of the exploded digital image capturing module assembly shown in FIG. 1;

FIG. 3 is a schematic sectional diagram used to depict a heating process during the fabrication of the digital image capturing module assembly according to the invention;

FIG. 4 is a schematic sectional diagram showing a semi-finished product of the digital image capturing module assembly according to the invention after the heating process is completed;

FIG. 5 is a schematic sectional diagram used to depict the dispensing of a curable and flowable adhesive agent during the fabrication of the digital image capturing module assembly according to the invention; and

FIG. 6 is a schematic sectional diagram showing the finished product of the digital image capturing module assembly according to the invention.

### DETAILED DESCRIPTION OF PREFERRED EMBODIMENTS

The digital image capturing module assembly and method of fabricating the same according to the invention is disclosed in full details by way of preferred embodiments in the following with reference to the accompanying drawings.

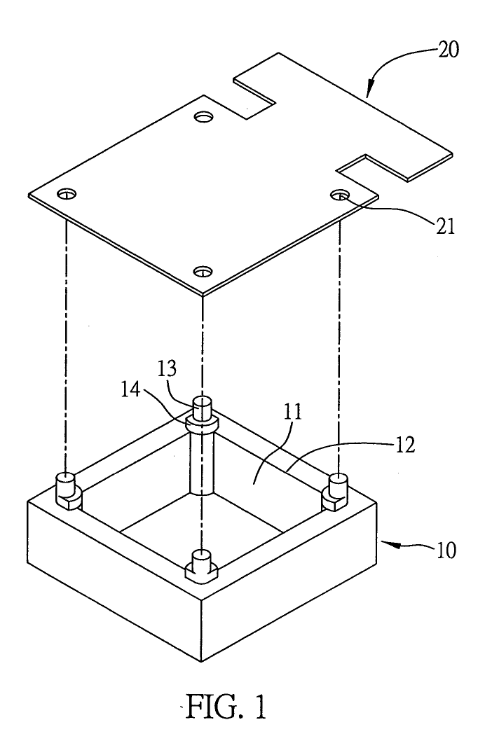

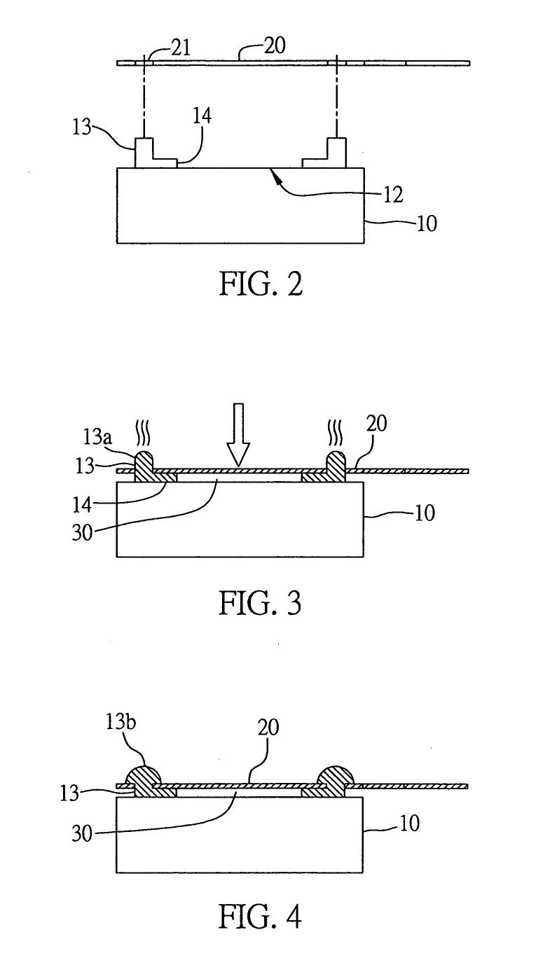

Referring first to FIG. 1 and FIG. 2, the initial steps in the fabrication of a digital image capturing module assembly according to the invention is to prepare a lens holder 10 and a photosensitive printed circuit board 20.

The lens holder 10 has an inside hollowed portion 11 for the accommodation of a lens unit (not shown) therein, and the lens unit is to be used to capture an optimal image and focus the captured image on a focusing plane 12 on the rear side of the lens holder 10. Further, the lens holder 10 is formed with a plurality of aligning posts, for example 4 aligning posts 13, on the periphery of the focusing plane 12. These aligning posts 13 are made of a thermally-meltable material, such as plastics, that can be melted when subjected to heat. It is a characteristic key part of the invention is that the lens holder 10 is formed with a plurality of stair-like bulged portions 14 respectively beside the aligning posts 13. Moreover, the aligning posts 13 should be each greater in length than the total of the height of the stair-like bulged portions 14 plus the thickness of the photosensitive printed circuit board 20.

The photosensitive printed circuit board 20 is, for example, a CCD (Charge Coupled Device) based or a CMOS (Complementary Metal Oxide Semiconductor) based photosensitive device, which is to be used to convert the optical image captured by the lens unit (not shown) in the lens holder 10 into digital form. In structural design, the photosensitive printed circuit board 20 is formed with a plurality of aligning holes 21 on the periphery thereof, whose size and position are correspondingly mapped to the aligning posts 13 on the lens holder 10.

Referring next to FIG. 3, during the assembly process, the first step is to perform a mounting process to mount the photosensitive printed circuit board 20 onto the lens holder 10 by fitting the aligning holes 21 in the photosensitive printed circuit board 20 against the aligning posts 13 on the lens holder 10. Since the aligning posts 13 are each greater in length than the total of the height of the stair-like bulged portions 14 plus the thickness of the photosensitive printed circuit board 20, the respective tips 13a of the aligning posts 13 will be protruding over the photosensitive printed circuit board 20. Moreover, due to the stair-like bulged portions 14 acting as a stopper against the photosensitive printed circuit board 20, there will exist an undergap 30 between the photosensitive printed circuit board 20 and the lens holder 10. As the photosensitive printed circuit board 20 is fitted in position, a heating process is then performed to apply heat against the protruding tips 13a of the aligning posts 13 with a downward pressing force (as indicated by the arrow in FIG. 3) being applied against the photosensitive printed circuit board 10, for the purpose of melting down the protruding tips 13a of the aligning posts 13.

Referring further to FIG. 4, after the protruding tips 13a of the aligning posts 13 have been melted and cured, they are each transformed into a bolting structure 13b which can help firmly secure the photosensitive printed circuit board 20 in position on the lens holder 10.

Referring next to FIG. 5, in the subsequent step, a dispensing process is performed to dispense a predetermined amount of curable and flowable adhesive agent 40 against the undergap 30 between the photosensitive printed circuit board 20 and the lens holder 10. After being dispensed, the curable and flowable adhesive agent 40 is able to self-infiltrate into the undergap 30 through capillary attraction.

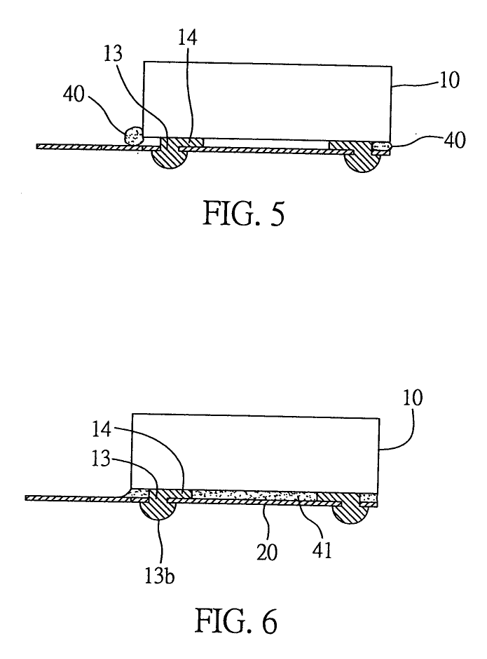

Referring finally to FIG. 6, through capillary attraction , the curable and flowable adhesive agent 40 would substantially fill up the entire empty space of the undergap 30 between the photosensitive printed circuit board 20 and the lens holder 10, without the existence of uncoated blank areas around the aligning posts 13. As a result, after the adhesive agent 40 is cured, it can serve as a light-impenetrable sealing layer 41 having no holes at the corners of the periphery of the focusing plane 12, so as to be capable of providing an absolutely sealed light-impenetrable effect at the junction between the photosensitive printed circuit board 20 and the lens holder 10.

In practical application, since the light-impenetrable sealing layer 41 can provide an absolutely sealed light-impenetrable effect at the junction between the photosensitive printed circuit board 20 and the lens holder 10, it allows the captured image by the finished product of the digital image capturing module to be substantially free of sidelight and thus more assured in picture quality.

In conclusion, the invention provides a digital image capturing module assembly and method of fabricating the same for use to assemble a digital image capturing module from a photosensitive printed circuit board and a lens holder, which is characterized by the provision of a plurality of stair-like bulged portions respectively beside the aligning posts on the lens holder to allow the formation of an undergap between the photosensitive printed circuit board and the lens holder so as to allow a curable and flowable adhesive agent to self-infiltrate into and substantially fill up the undergap through capillary attraction, thereby forming a light-impenetrable sealing layer at the junction between the photosensitive printed circuit board and the lens holder without the existence of uncoated blank areas around the aligning posts. This feature allows the light-impenetrable sealing layer to provide an absolutely sealed light-impenetrable effect at the junction between the photosensitive printed circuit board and the lens holder so that the captured image by the finished product of the digital image capturing module would be substantially free of sidelight and thus more assured in picture quality. Moreover, since it would be unnecessary to fill up corner-located holes by labor force, the invention can help increase the yield of the fabrication of digital image capturing modules. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

1. A digital image capturing module assembly, which comprises:
a lens holder, which has one side defined as a focusing plane, and which is formed with a plurality of aligning posts on the periphery of the focusing plane and is further formed with a plurality of stair-like bulged portions respectively beside the aligning posts;
a photosensitive printed circuit board, which is formed with a plurality of aligning holes corresponding to the aligning posts on the lens holder, and which is mounted on the lens holder by fitting the aligning holes thereof against the aligning posts on the lens holder, with the respective tips of the aligning posts on the lens holder being each melted into a bolting structure to secure the photosensitive printed circuit board firmly in position on the lens holder, with an undergap existing between the photosensitive printed circuit board and the lens holder due to the stair-like bulged portions acting as a stopper against the photosensitive printed circuit board; and
a light-impenetrable sealing layer, which is infiltrated in the undergap between the photosensitive printed circuit board and the lens holder to provide a sealed light-impenetrable effect at the junction between the photosensitive printed circuit board and the lens holder.

2. The digital image capturing module assembly of claim 1, wherein the photosensitive printed circuit board is a CCD-based photosensitive device.

3. The digital image capturing module assembly of claim 1, wherein the photosensitive printed circuit board is a CMOS-based photosensitive device.

4. The digital image capturing module assembly of claim 1, wherein the aligning posts on the lens holder are made of plastics.

5. A method for fabricating a digital image capturing module, comprising:
preparing a lens holder, which has one side defined as a focusing plane, and which is formed with a plurality of aligning posts on the periphery of the focusing plane and is further formed with a plurality of stair-like bulged portions respectively beside the aligning posts;
preparing a photosensitive printed circuit board which is formed with a plurality of aligning holes corresponding to the aligning posts on the lens holder;
mounting the photosensitive printed circuit board onto the lens holder by fitting the aligning holes in the photosensitive printed circuit board against the aligning posts on the lens holder, with an undergap existing between the photosensitive printed circuit board and the lens holder due to the stair-like bulged portions acting as a stopper against the photosensitive printed circuit board;
melting the respective tips of the aligning posts on the lens holder so as to transform the respective tips of the aligning posts into a bolting structure to secure the photosensitive printed circuit board firmly in position on the lens holder; and
dispensing a curable and flowable adhesive agent against the undergap between the photosensitive printed circuit board and the lens holder, allowing the curable and flowable adhesive agent to self-infiltrate into and substantially fill up the undergap through capillary attraction to provide a sealed light-impenetrable effect at the junction between the photosensitive printed circuit board and the lens holder.

6. The method of claim 5, wherein the photosensitive printed circuit board is a CCD-based photosensitive printed circuit board.

7. The method of claim 5, wherein the photosensitive printed circuit board is a CMOS-based photosensitive printed circuit board.

8. The method of claim 5, wherein the aligning posts on the lens holder are made of plastics.
